(19) United States
(12) Patent Application Publication
(10) Pub. No.: US 2025/0242517 A1
(43) Pub. Date: Jul. 31, 2025

(54) OUTDOOR TOOL WITH REMOVABLE LUBRICATION RESERVOIR

(71) Applicant: Milwaukee Electric Tool Corporation, Brookfield, WI (US)

(72) Inventors: Beth E. Cholst, Brookfield, WI (US); Hans Banzholder, Brookfield, WI (US); Dylan Konop, Brookfield, WI (US)

(21) Appl. No.: 19/040,014

(22) Filed: Jan. 29, 2025

Related U.S. Application Data
(60) Provisional application No. 63/626,750, filed on Jan. 30, 2024.

(51) Int. Cl. B27B 17/12; B27B 17/02; F16N 7/40; F16N 19/00

(52) U.S. Cl. CPC B27B 17/12; B27B 17/02; F16N 7/40; F16N 19/00

(57) ABSTRACT

An outdoor tool and a lubrication system for an outdoor tool are provided. The lubrication system for a power tool includes a reservoir, a pump, an output configured to supply a lubricant to a tool unit of the power tool, and a housing. The lubrication system is configured to transport the lubricant from the reservoir to the output. The pump is disposed within the housing. The reservoir is removably coupled to the housing.

### CROSS-REFERENCE TO RELATED APPLICATIONS

The present application claims priority to U.S. Provisional Patent Application Ser. No. 63/626,750 filed on Jan. 30, 2024, the disclosure of which is incorporated by reference herein in its entirety.

### FIELD

The present disclosure relates generally to lubrication systems for outdoor power tools, e.g., chain saws, pole saws and the like, and particularly to lubrication systems having a removable lubrication tank.

### BACKGROUND

Outdoor tools, such as pole saws and handheld chainsaws, are used to perform outdoor tasks such as cutting tree branches and other vegetation. Pole saws and chainsaws cut through material using chains with cutting teeth. The chain is typically disposed in a track on a guide bar. The chain moves relative to the track, advancing the cutting teeth along the material being cut.

Frictional resistance between the chain and guide bar decreases saw efficiency. That is, the additional resistance between the chain and guide bar results in decreased energy capacity and fewer cuts which can be made between charging or refueling. To solve this problem, lubrication may be introduced between the chain and guide bar. However, too much lubrication can attract debris, interfere with electronic components of the tool, create a worse user experience, or even cause dripping.

Accordingly, improved outdoor tool oiling systems are desired in the art. In particular, lubrication systems which offer removability of a lubrication tank from a tool would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a lubrication system for a power tool is provided. The lubrication system includes a reservoir, a pump, an output configured to supply a lubricant to a tool unit of the power tool, and a housing. The lubrication system is configured to transport the lubricant from the reservoir to the output. The pump is disposed within the housing. The reservoir is removably coupled to the housing.

In accordance with another embodiment, a tool is provided. The tool includes: a housing; a motor assembly disposed within the housing; a tool unit powered by the motor assembly, the tool unit including a guide bar and a chain circumscribing a portion of the guide bar; and a lubrication system that provides lubricant to the chain. The lubrication system includes: a reservoir housing the lubricant, a pump, an output configured to supply the lubricant to the guide bar and the chain. The reservoir is removably coupled to the housing.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a partial cutaway view of a power tool and lubrication system in accordance with embodiments of the present disclosure;

FIG. 2 is a perspective view of a connection in accordance with embodiments of the present disclosure;

FIG. 3 is a perspective view of a flow indicator in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present invention is directed to a power tool and a lubrication system for a power tool having a removable lubricant reservoir. The lubricant reservoir may be removably coupled from the exterior of the housing of the tool. The lubricant reservoir may be removed from the tool housing when the tool is not in use, thereby reducing the incidence of leakage of lubricant from the tool during storage.

The present invention is directed to a tool 100 in accordance with exemplary embodiments of the present disclosure. In particular, the tool 100 may be a chain saw. The tool 100 has a lubrication system 102 associated with a housing 104 of the tool 100. For instance, at least a portion of the lubrication system 102 may be disposed within the housing 104 and at least a portion of the lubrication system 102 may be disposed outside of the housing 104. The tool 100 can further include a tool unit such as a guide bar assembly 106 including a guide bar that receives a chain (not shown), e.g., circumscribed around the guide bar, a motor assembly 110 within the housing 104, a control assembly 112, a battery receiver 114, a battery 116 to power the tool 100, or any combination thereof.

The lubrication system 102 will now be described in further detail. The lubrication system 102 is configured to supply lubricant to the tool 100 and transport lubricant to the tool unit, e.g., guide bar 106. The lubrication system 102 includes a lubricant reservoir 130 configured to house a lubricant 132. The lubricant reservoir 130 is fluidly coupled to a pump 134 via a first hose 136, also referred to as a hose or a first hose. Downstream of the pump 134, a second hose 138 fluidly couples the pump 134 to an output 140 configured to dispense the lubricant adjacent to the chain so as to lubricate the chain. The pump 134 can draw lubricant 132 from the reservoir 130 via the hose 136 and deliver lubricant through the second fluid conduit 138 to provide the lubricant at a location adjacent to the chain. The pump 134 may be any suitable pump configured to pump lubricant through the tool. Advantageously, the pump 134 may further include one or more backflow-prevention features and/or leak-prevention features to minimize leakage of lubricant from the lubrication system.

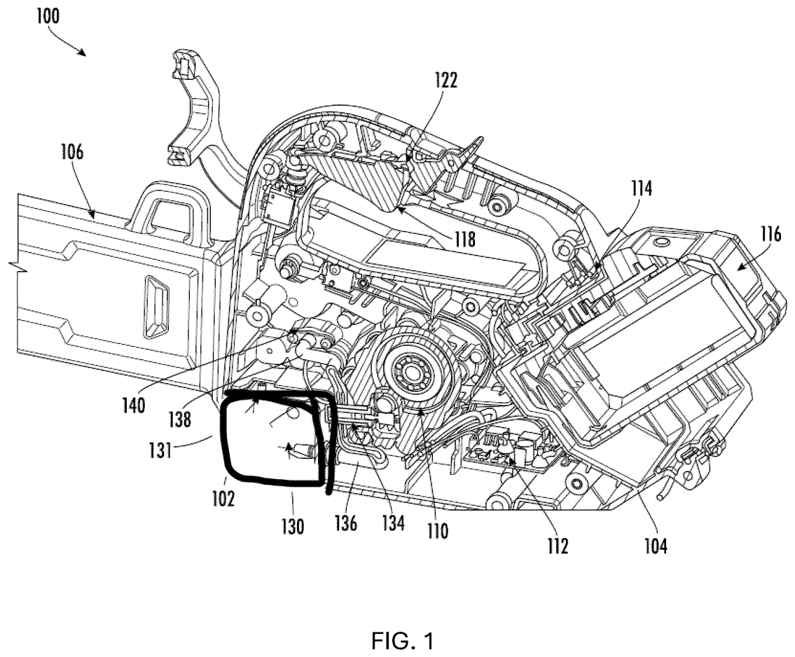

As illustrated in FIG. 1, the lubricant reservoir 130 may be located outside the housing 104. For instance, the lubricant reservoir 130 may be removably coupled to the exterior of the housing 104. The pump 134 and hoses 136, 138 may be located within the housing 104. As described further below, a connection 150 may be provided to fluidly couple the reservoir 130 with the first hose 136.

In some embodiments, the housing 104 and the reservoir 130 may have a complementary form in which the reservoir 130 does not substantially extend beyond or outside a footprint of the housing 104. For instance, a portion of the housing 104 may be concave or indented, and the reservoir may fill the concave or indented space. In this manner, the center of mass of the tool 100 may be generally central to the tool 100. In other embodiments, the reservoir 130 may be coupled to the housing 104 extending beyond a footprint of the housing 104, which may move the center of mass of the tool to an offset position in comparison.

The reservoir 130 may be mounted or coupled to an exterior of the housing 103. The reservoir 130 may be provided with one or more coupling members configured to couple the reservoir body of the reservoir 130 to the housing 104. For instance, the one or more coupling members may include a latching feature. The latching feature may include but is not limited to: a clip, a hook, a spring, a detent, a lock, etc. The housing 104 may include a complementary latching feature configured to receive the reservoir 130 to secure the reservoir 130 thereto.

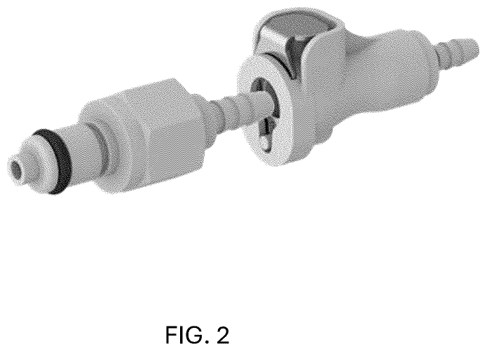

The connection 150 may be in the form of a valve. The valve may be a one-way valve and/or shut-off valve that permits lubricant 132 to flow from the reservoir 130 into the first hose 136 and prevents backflow or leakage of lubricant out of the connection 150. In this manner, the connection 150 may form a lubricant flow shutoff mechanism. The connection 150 of the reservoir 130 may include a quick disconnect style connection such as, but not limited to, a stem as illustrated in FIG. 2. The quick disconnect style connection 150 may facilitate ease of connection between the reservoir 130 and the first hose 136 of the lubrication system.

In this manner, the lubricant reservoir 130 may be uncoupled from the housing 104, removed from the housing 104, and stored separately when the tool 100 is not in use. By separating the reservoir 130, the incidence of lubricant leakage from the tool 100 during storage may be decreased, as the source of lubricant (i.e., the reservoir 130) is separated from the tool 100. Additionally, the reservoir 130 can be stored in a position configured to prevent leakage of lubricant out of the reservoir 130.

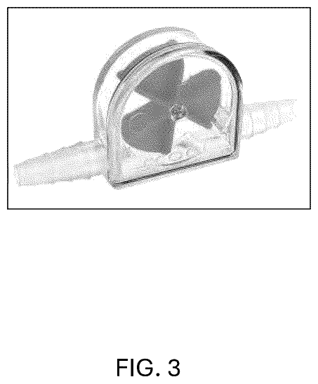

In some aspects, one or more additional elements of the lubrication system may be external to the housing 104. For instance, the lubrication system may be provided with an indicator external to the housing 104 that may be visible to a user. Examples of an indicator may include a flow rate indicator, a low oil indicator, or a combination thereof. For example, FIG. 3 illustrates a flow indicator 160 having a clear (i.e., transparent or translucent) housing configured to be disposed outside the housing 104 so a user can visually identify if lubricant is flowing through the lubrication system and/or if there is no lubricant left. The indicator can be disposed at any suitable point along the lubrication system flow path but may preferably be disposed downstream of the pump.

Further aspects of the invention are provided by one or more of the following embodiments:

A lubrication system for a power tool including a reservoir, a pump, an output configured to supply a lubricant to a tool unit of the power tool, and a housing. The lubrication system is configured to transport the lubricant from the reservoir to the output. The pump is disposed within the housing. The reservoir is removably coupled to the housing.

The lubrication system of any one or more of the embodiments, wherein the reservoir is removably coupled to an exterior of the housing.

The lubrication system of any one or more of the embodiments, further comprising a means for preventing leakage of lubricant from the housing.

The lubrication system of any one or more of the embodiments, wherein the means for preventing leakage of lubricant comprises a shut-off valve.

The lubrication system of any one or more of the embodiments, the reservoir comprising a reservoir body and a latching feature configured to couple the reservoir body to the housing.

The lubrication system of any one or more of the embodiments, the latching feature comprising a clip, a hook, a spring, a detent, and/or a lock.

A tool including: a housing; a motor assembly disposed within the housing; a tool unit powered by the motor assembly, the tool unit including a guide bar and a chain circumscribing a portion of the guide bar; and a lubrication system that provides lubricant to the chain. The lubrication system includes: a reservoir housing the lubricant, a pump, an output configured to supply the lubricant to the guide bar and the chain. The reservoir is removably coupled to the housing.

The tool of any one or more of the embodiments, wherein the pump is disposed within the housing.

The tool of any one or more of the embodiments, wherein the reservoir is removably coupled to an exterior of the housing.

The tool of any one or more of the embodiments, the reservoir comprising a reservoir body and a latching feature configured to couple the reservoir body to the housing.

The tool of any one or more of the embodiments, the housing comprising a complementary latching feature configured to receive the latching feature of the reservoir.

The tool of any one or more of the embodiments, further comprising a means for preventing leakage of lubricant from the housing.

The tool of any one or more of the embodiments, the means for preventing leakage of lubricant from the housing comprising at least one shut-off valve.

The tool of any one or more of the embodiments, wherein the reservoir comprises a shut-off valve and the housing comprises a shut-off valve.

An apparatus as shown and described in one or more embodiments herein.

A system configured to operate in accordance with any one or more embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A lubrication system for a power tool, comprising:
a reservoir, a pump, an output configured to supply a lubricant to a tool unit of the power tool, and a housing;
wherein the lubrication system is configured to transport the lubricant from the reservoir to the output;
the pump being disposed within the housing; and
the reservoir being removably coupled to the housing.

2. The lubrication system of claim 1, wherein the reservoir is removably coupled to an exterior of the housing.

3. The lubrication system of claim 1, further comprising a means for preventing leakage of lubricant from the housing.

4. The lubrication system of claim 3, wherein the means for preventing leakage of lubricant comprises a shut-off valve.

5. The lubrication system of claim 1, the reservoir comprising a reservoir body and a latching feature configured to couple the reservoir body to the housing.

6. The lubrication system of claim 5, the latching feature comprising a clip, a hook, a spring, a detent, and/or a lock.

7. A tool comprising:
a housing;
a motor assembly disposed within the housing;
a tool unit powered by the motor assembly, the tool unit comprising:
a guide bar and a chain circumscribing a portion of the guide bar; and
a lubrication system that provides lubricant to the chain, the lubrication system comprising:
a reservoir housing the lubricant,
a pump,
an output configured to supply the lubricant to the guide bar and the chain,
the reservoir being removably coupled to the housing.

8. The tool of claim 7, wherein the pump is disposed within the housing.

9. The tool of claim 7, wherein the reservoir is removably coupled to an exterior of the housing.

10. The tool of claim 7, the reservoir comprising a reservoir body and a latching feature configured to couple the reservoir body to the housing.

11. The tool of claim 10, the housing comprising a complementary latching feature configured to receive the latching feature of the reservoir.

12. The tool of claim 7, further comprising a means for preventing leakage of lubricant from the housing.

13. The tool of claim 12, the means for preventing leakage of lubricant from the housing comprising at least one shut-off valve.

14. The tool of claim 13, wherein the reservoir comprises a shut-off valve and the housing comprises a shut-off valve.
